(19) United States
(12) Patent Application Publication
(10) Pub. No.: US 2014/0173953 A1
(43) Pub. Date: Jun. 26, 2014

(54) LIGHTED SIGN

(71) Applicant: Zeon Corporation, Louisville, CO (US)

(72) Inventors: Alan Bloom, Boulder, CO (US); Scott Adcock, Thornton, CO (US)

(73) Assignee: Zeon Corporation, Louisville, CO (US)

(21) Appl. No.: 13/947,544

(22) Filed: Jul. 22, 2013

Related U.S. Application Data
(60) Provisional application No. 61/739,965, filed on Dec. 20, 2012.

(51) Int. Cl. G09F 13/18

(52) U.S. Cl. CPC G09F 13/18
USPC 40/546

(57) ABSTRACT

A lighted sign comprising one or more sign sections, wherein each of the one or more sign sections comprises a front surface a rear surface, one of operatively integrated and coupled to the front surface, one or more bores extending from the front surface to the rear surface, and a light source positioned to project light through at least a portion of the at least one side surface. Furthermore, the one or more bores comprise at least one side surface.

### PRIORITY

This application claims priority to U.S. Provisional Application No. 61/739,965, filed Dec. 20, 2012 and entitled Lighted Sign, which is incorporated herein by reference in its entirety.

### FIELD OF THE INVENTION

The present invention is related to signage. Specifically, but not intended to limit the invention, embodiments of the invention are related to a lighted sign having negative space therein.

### BACKGROUND OF THE INVENTION

Lighted signs are currently designed for use with various different features. For example, simple back-lit lighted signs illuminate the display placed in front of the light source. Other types of lighted signs include neon signs, LED signs, and combinations of these and other sign types. However, many signs which create a more robust and creative display are desired. Current signs offering such robust and creative displays are expensive and are therefore unable to be purchase by many retailers and vendors.

### SUMMARY OF THE INVENTION

In order to provide a broader base of customers with lighted signs through offering robust and creative displays at a lower cost, a lighted sign, a method of using a lighted sign, and a lighted display system were developed. One embodiment of a lighted sign comprises one or more sign sections. Each of the one or more sign sections may comprise a front surface, a rear surface one of operatively integrated and coupled to the front surface and one or more bores extending from the front surface to the rear surface. The one or more bores comprise at least one side surface. The lighted sign further comprises a light source positioned to project light through at least a portion of the at least one side surface.

Another embodiment of the invention comprises a method of using a lighted sign. One such method comprises emanating light from one or more light sources in the lighted sign and using one or more bore holes in one or more lighted sign layers to create at least one of a halo and a light piping effect.

Yet another embodiment of the invention comprises a lighted display system. One lighted sign system comprises an outer edge, one or more horizontal lighted display layers, a display on a lighted display front surface, and an opaque backplane. At least a portion of one outer edge comprises one or more light sources emanating light generally towards a lighted display center. Furthermore, at least one of the horizontal lighted display layers is substantially transparent.

Illustrative embodiments of the present invention that are shown in the drawings are summarized herein. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

### BRIEF DESCRIPTION ON THE DRAWINGS

Various objects and advantages and a more complete understanding of the present invention are apparent and more readily appreciated by reference to the following Detailed Description and to the appended claims when taken in conjunction with the accompanying Drawings, where like or similar elements are designated with identical reference numerals throughout the several views and wherein:

FIG. 1 illustrates a front view of a lighted sign according to one embodiment of the invention;

FIG. 2 illustrates a back view of a lighted sign according to one embodiment of the invention;

FIG. 3 illustrates a isometric view of a portion of a lighted sign according to one embodiment of the invention;

FIG. 3A illustrates a side view of a portion of the lighted sign seen in FIG. 3 according to one embodiment of the invention; and

FIG. 4 illustrates a flowchart that depicts a method that may be carried out in connection with the embodiments described herein.

### DETAILED DESCRIPTION

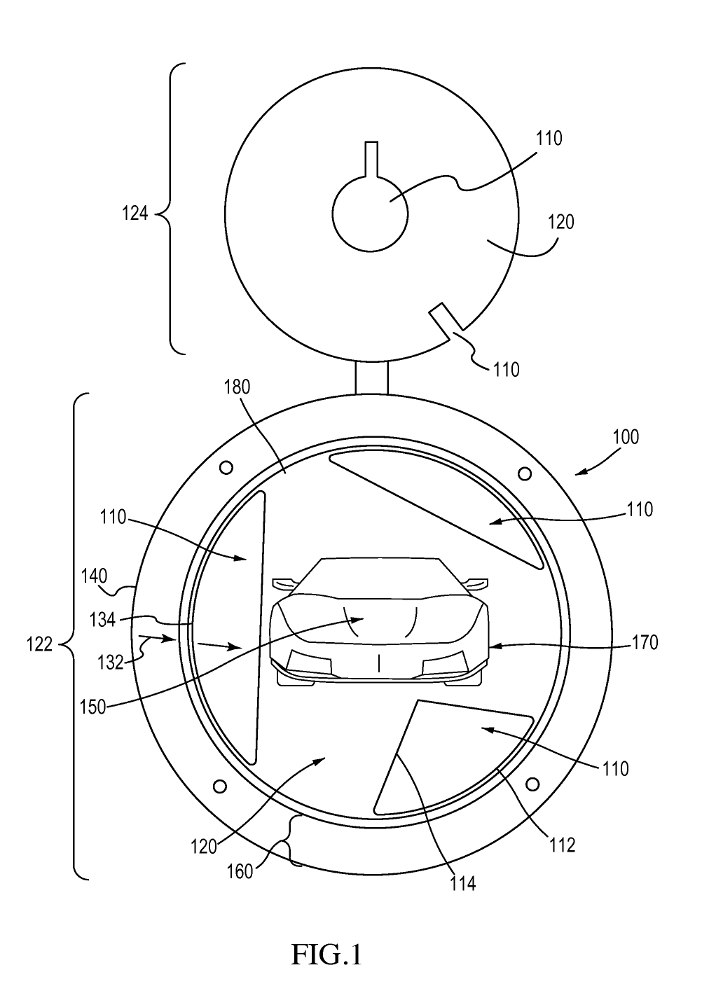

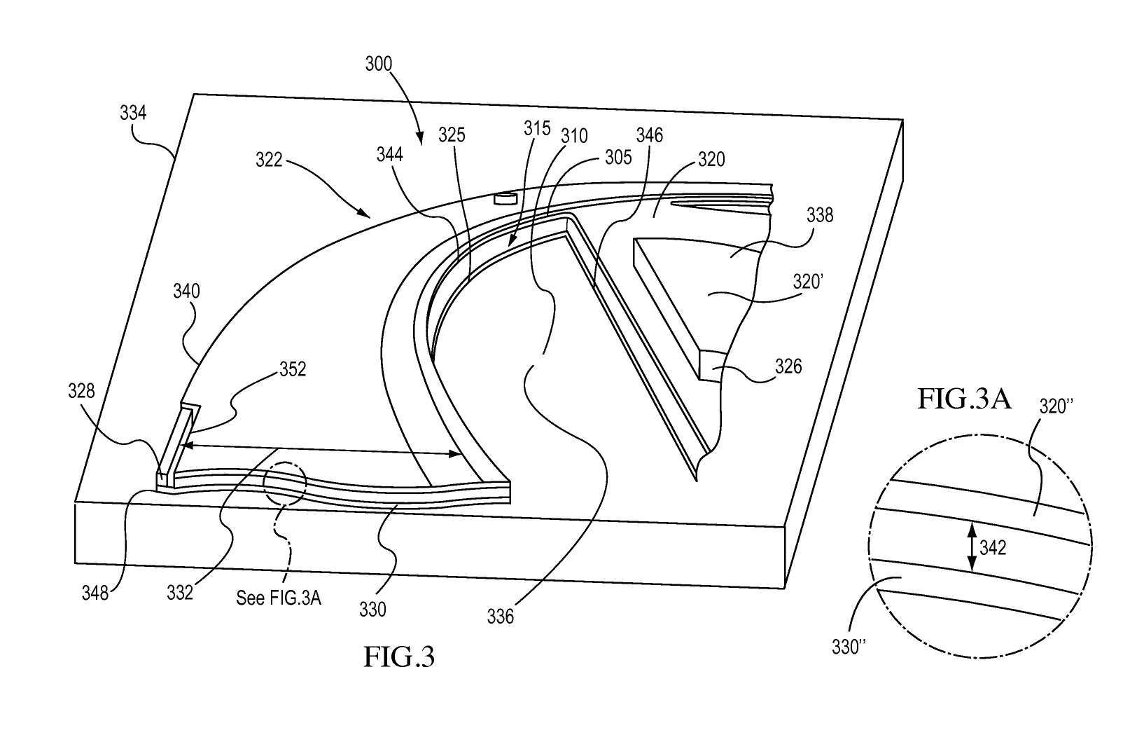

Turning first to FIG. 1, seen is one embodiment of the invention comprising a lighted sign 100. As seen, the lighted sign 100 may comprise one or more sign sections, such as, but not limited to, the first section 122 and second section 124 of FIG. 1. Alternatively, the second section 124 may comprise a portion of the first section 122. For example, turning to FIG. 3, the first section 322 may comprise one or more raised sections 326. Each raised section 326 may comprise a second section.

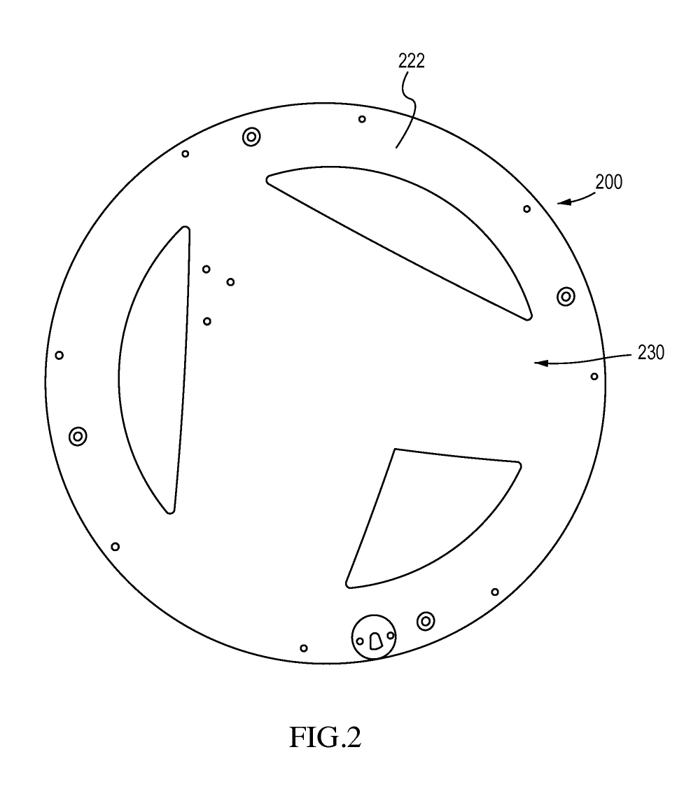

Returning now to FIG. 1, seen are each of the one or more sign sections 122, 124 comprising a front surface 120. Furthermore, as seen in FIG. 2 the first section 222 also comprises a rear surface 230. The second section 124 seen in FIG. 1, or any other section may also comprise a rear surface 230, where appropriate. However, the raised sections 326 seen in FIG. 3 and other raised section 326 may comprise the rear surface 230 of the first section 322. When the raised sections 326 and/or second section 124 comprise a front surface 120, the lighted sign 100, 300 may comprise a plurality of front surfaces 120. Furthermore, the lighted sign 100, 300 may also comprise a plurality of rear surfaces 222 and/or side surfaces 348 in a similar manner.

In one embodiment, the rear surface 230 and front surface 120 seen in FIGS. 1 and 2, respectively, may comprise opposing surfaces of a polymeric material. One such polymeric material may comprise a substantially transparent material such as, but not limited to, acrylic. However, other types of polymeric materials are contemplated. Additionally, the front surface 120 may comprise one surface of a first material and the rear surface 230 may comprise a surface of another, second, material one or coupled and integrated to the first material. The two materials comprising two layers may be coupled through the use of, for example, an adhesive. Other coupling mechanisms known in the art such as, but not limited to, a nut-bolt fastening system may be used. Other or additional layers may be coupled or integrated in a similar manner. Non-polymeric materials may also be used as at least a portion of one or more layers such as, but not limited to, metal and wood. Furthermore, the rear surface 230 may comprise a substantially opaque surface.

If the front surface 120 and rear surface 230 comprise opposing surfaces of a single unitary material, they may be operatively integrated and if the front surface 120 and rear surface 230 comprise two or more materials, they may be operatively coupled together. More than two layers of one or more materials may be coupled together as well.

As seen in FIGS. 1 & 2, one or more bores 110 may extend from the front surface 120 to the rear surface 230. The bores 110 may be referred to herein as a “negative space” in the lighted sign 100. The bores 110 may comprise a removed portion of the lighted sign 100. In one embodiment, the bores 110 may not extend from the front surface 120 to the rear surface 230, but may only extend partially from the front surface 120 to the rear surface 230, or vice versa. For example, the bores 110 may extend only through one or more layers or a portion of one or more layers comprising one or more materials making up the light sign 100.

Seen in FIG. 3 is an embodiment of a lighted sign 300 comprising three layers—a first layer 305, a second layer 315, and a third layer 325. FIG. 3 is a close-up view of a section of the lighted sign 100 seen in FIG. 1. FIG. 3 shows that the lighted sign 300 may be comprised of one or more horizontal sections, or layers. Each of the one or more layers may comprise a polymeric material such as, but not limited to, acrylic. In one embodiment, there may be a first section 305, second section 315, and a third section 325. As seen in the cut-away section 352 of the FIG. 3, a light source 328 may be placed proximal an outer edge 340 of the lighted sign 300. The light source 328 in FIG. 3 is place near an outer edge the second layer 315 of the lighted sign 300. In such an embodiment, the second layer 325 may comprise a substantially transparent layer. However, it is also contemplated that one or more surfaces of the second layer 315 may comprise a reflective material or may comprise an opaque surface or may comprise one or more colors, designs or texts. Each of the first layer 305, third layer 325, and/or any other layer in the lighted sign 300 may comprise one or more of a colored, transparent, and/or reflective portion or section of a surface of an entire section of the layer. For example, the front surface 320 or raised front surface 320′ may comprise at least one of a graphical and textual display in one or more reflective or opaque colors. However, such graphical and textual display in one or more colors may also be embedded within or on any other of the one or more layers or surfaces or edges. As seen in FIG. 3A, each of the layers 305, 315, 325, or any other layer within the lighted sign 300 may also comprise an inner portion 342 which extends between a front surface 320″ and rear surface 330″ of the layer.

When one second layer 315 comprises a substantially transparent material, the second layer 315 may be adapted to let the LED light transmit through the second layer 315. Furthermore, if a rear surface 330 comprises an opaque surface, or if one or more portions or any other surface or the entire material comprises a reflective and/or opaque or colored nature, such portions may limit or enhance the amount of light traveling through each section. For example, opaque sections of at least portions the first section 305 and third section 325 in FIG. 3 may limit the amount of LED light transmitted to the bore as compared to one or more reflective sections of portions the first section 305 and third section 325.

In one embodiment, as light is emitted from the light source 328, the light may travel generally perpendicularly away from the light source 328 through the one or more layers, as seen with the direction arrow 132, 332 in FIGS. 1 and 3. The use of reflective, colored and/or opaque surfaces and/or materials, may enable a light-piping effect through at least a portion of the lighted sign 300, 100. The light-piping effect may occur in the second layer 315. As the light hits the at least one outer bore side surface 132, at least a portion of the light may project into an attachment surface 334. The attachment surface 334 may comprise the surface that the lighted sign 300 is coupled to—such as, but not limited to, a wall. The light projecting onto the attachment surface 334 may comprise a halo effect around the bore 310. For example, the attachment surface 334 may appear brighter proximal a bore side surface 344 than in a center 336 the bore 310. The bore side surface 344 seen in FIG. 3 may be referred to herein as an outer side surface as it is located closer to the outer edge 340 than an inner side surface 346. In one embodiment, the light may be projected from the outer side surface 344 and to the at least one inner side surface 346. Multiple light source locations 328 may be placed throughout the sign to create a halo effect on the attachment surface proximal a bore 310.

In order to obtain sufficient light at the center 150 of the lighted sign 100, as seen in FIG. 1, an outer edge 340 positioned one or more LED lights, which may be referred to herein as LEDs or L.E.D.'s, may also travel across the bore 110 into the inner side surface 346, and may also travel through integration locations 180. The center 150 may also be referred to herein as a center portion. Integration locations 180 may comprise portions of a front surface 120 that integrate a first section 160 of the front surface 120 to a second section 170 of the front surface 120. As seen in FIG. 1, the first section 160 may comprise a portion of the front surface between the outer edge 140 and the bore 110 while the second section 170 may comprise a portion of the front surface 120 between the bore 110 and the center 150. The second section 170 may also be referred to herein as a middle portion. In one embodiment where the light source 328, as seen in FIG. 3, is located proximal the outer edge 340, the center portion may receive at least about 75% of the amount of light as one or more locations in the middle portion, from the light source 328. It is further contemplated that the third layer 325 may comprise a backplane, wherein at least a portion of the backplane comprises a reflective surface and/or an opaque material.

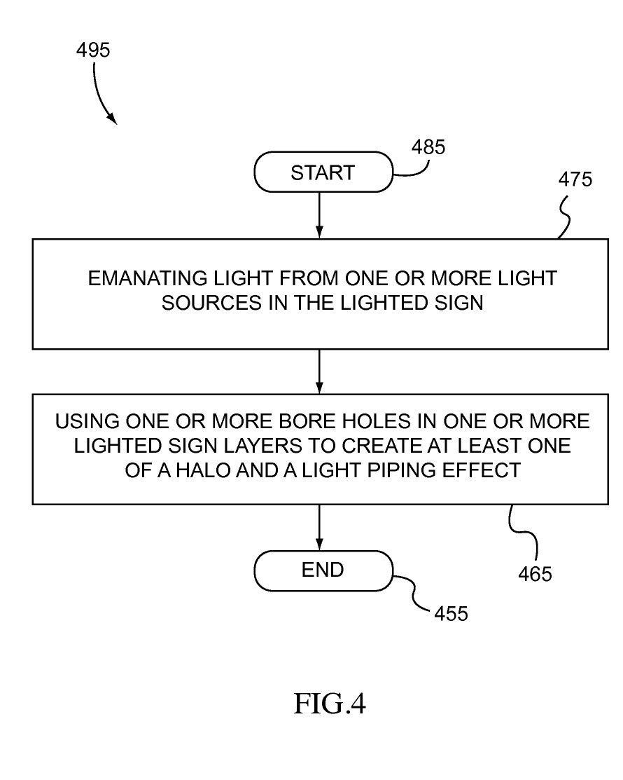

Turning now to FIG. 4, seen is a method 495 of using a lighted sign. One such method 495 starts at 485 and at 475 comprises emanating light from one or more light sources in alighted sign. For example, the one or more light sources may comprise the light source 328 in the lighted sign 300 seen in FIG. 3. However, other light sources 328 and light source locations that are different from the light source 328 and location seen in FIG. 3 are contemplated. Moving to 465, the method 495 comprises using the one or more bore holes such as, but not limited to, the bore holes 110 seen in FIG. 1, in one or more lighted sign layers, such as, but not limited to the layers 305, 315, 325 seen in FIG. 3, to create at least one of a halo and a light piping effect.

For example, and as explained above with reference to FIG. 3, light from a light source 328 may travel away from the light source 328 in a direction 332 towards a bore hold 310. Although the light source 328 seen in FIG. 3 is located proximal the outer edge 328, it is contemplated that the light source may be located in other locations such as, but not limited to, proximal a bore 310 or a lighted sign, as seen in FIG. 1. Upon reaching the bore 310, the light may create a halo effect on the attachment surface 334. Alternatively, the light may create a halo effect on a backplane. In such an embodiment, the backplane may comprise an additional layer in the lighted sign 300 and the bore 310 may only extend from the front surface 320 to through the layers from the front surface 320 and ending at the backplane. Therefore, the bore 310 may not extend through the entirety of the lighted sign 300. In one such embodiment, third layer 325 may comprise the backplane and the bore 310 may therefore only extend through the first layer 305 and second layer 315.

In another embodiment of the method 495 seen in FIG. 4, before emanating light from one or more light sources 328, the one or more light sources 328 may be placed near the outer edge 340 of the lighted sign 300 and between the lighted sign front surface 320 seen in FIG. 3 and the lighted sign rear surface 230 seen in FIG. 2. The method 495 may further comprise emanating light from one or more light sources 328 in the lighted sign 300 through the one or more bore holes 310.

In a method 495 where the one or more bore holes 310 comprises at least one outer side surface 344 and at least one inner side surface 346, light may project through at least a portion of the at least one outer side surface 344 and into the at least one inner side surface 346, or vice versa. Furthermore, before light enters or travels through the one or more bores 310, light may emanate through the one or more first sections 160 of the lighted sign 100, as seen in FIG. 1, when the light source 328 is located proximal the outer edge 140. After emanating light through the one or more bore holes 110, light may emanate through at least one layer in the one or more first or second sections 160, 170 and to a lighted sign center portion. It is contemplated that the light may travel in an opposing similar many from the center 150 to the outer edge 140. In emanating light through the one or more layers, at least one of the one or more first sections 160, one or more second sections 170, and lighted sign center portion may comprise a reflective, colored, transparent, or opaque surface or material.

Throughout the specification and claims, the term lighted sign 100 may also be referred to as a “lighted display system.” It is contemplated that one lighted display system front surface 120 may comprise a graphical, textual, or other type of display. For example, the graphical display seen in FIG. 1 is that of an automobile. Furthermore, the backplane discussed above may comprise an opaque backplane. Additionally, in one embodiment one or more first sections 160 or second section 170 of the front surface 120 may comprise an opaque portion. Such an opaque portion may also comprise one or more front surface 120 colors. In one such first section 160, light from the LEDs may not shine through the opaque portion and therefore may not be seen by a viewer of the sign through the one or more opaque portions. The one or more first section 160 and second sections 170 may also comprise one or more colors. The light emanating from the LEDs may shine through the color in the one or more first sections 160 and second sections 170. The light emanating from the colored portions may be displayed as a brighter and enhanced color. At least a portion of the one or more first sections 160 and second sections 170 may comprise a generally transparent portion.

Although FIG. 1 shows the bore 110 as being located throughout the one or more section sections 170, the bore 110 may also be located throughout the one or more first sections 160 or center 150. The additional back surface may enable the light emanating from the lighted sign to reflect back to a person viewing the sign from the front and may create various types of “halo” effects to the user, commonly-known in the art. For example, a halo effect may be created on the backplane proximal to each negative space 210. Additionally, the negative space 210 may increase light-piping effects, thereby creating additional unique sign features. Use of such negative spaces 210 may decrease costs in lighted signs 100 by creating features such as but not limited to the halo effect at a substantially lower cost than such features would otherwise cost.

In conclusion, embodiments of the present invention provide for a lighted sign having one or more negative spaces. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A lighted sign comprising one or more sign sections, wherein each of the one or more sign sections comprises,
a front surface;
a rear surface one of operatively integrated and coupled to the front surface;
one or more bores extending from the front surface to the rear surface, wherein the one or more bores comprise at least one side surface; and
a light source positioned to project light through at least a portion of the at least one side surface.

2. The lighted sign of claim 1 wherein, at least one of the front surface and the rear surface comprises a plurality of front surfaces and rear surfaces.

3. The lighted sign of claim 1 wherein, the front surface comprises at least one of a graphical and textual display in one or more colors.

4. The lighted sign of claim 1 further comprising,
an inner portion wherein, the inner portion,
is one of coupled and integrated to at least a portion of the front surface and rear surface; and
comprises a substantially transparent material.

5. The lighted sign of claim 1 wherein,
the one or more sign sections further comprise,
a middle portion,
a center portion, and
at least one outer edge;
the light source is located proximal the at least one out edge; and
the center portion receives at least 75% of the amount of light as the middle portion from the light source.

6. The lighted sign of claim 1 wherein,
the light source comprises one or more LEDs; and
one or more sections of the front surface, rear surface, and side surface comprise at least one of,
an opaque section,
a section comprising one or more colors; and
a reflective surface.

7. The lighted sign of claim 1 wherein,
the at least one side surface comprises,
an outer side surface, and
an inner side surface; and
the light is projected through at least a portion of the outer side surface and into the at least one inner side surface.

8. The lighted sign of claim 1 wherein,
the one or more sign sections comprise a plurality of layers;
at least a portion of a first of the plurality of layers comprises a substantially transparent polymeric material;
at least a portion of a second of the plurality of layers comprises a substantially opaque layer; and
a third of the plurality of layers comprises a backplane, wherein at least a portion of the backplane comprises a reflective surface.

9. The lighted sign of claim 8 wherein, at least one of, a halo and a light-piping effect are created.

10. The lighted sign of claim 9 wherein,
the halo is created on the backplane proximate to the one or more bores; and
the light-piping effect is created in one or more layers.

11. The lighted sign of claim 10 wherein,
the light piping effect is created in a second of three layers; and
a third layer comprises a backplane.

12. A method of using a lighted sign comprising,
emanating light from one or more light sources in the lighted sign; and
using one or more bore holes in one or more lighted sign layers to create at least one of a halo and a light piping effect.

13. The method of claim 12 further comprising,
before emanating light from one or more light sources, placing the one or more light sources,
near an outer edge of the lighted sign, and
between a lighted sign front surface and a lighted sign rear surface; and
wherein,
emanating light from one or more light sources in the lighted sign comprises emanating light through the one or more bore holes.

14. The method of claim 13 wherein,
the one or more bore holes comprises at least one outer side surface and at least one inner side surface; and
emanating light through the one or more bore holes comprises projecting light through at least a portion of the at least one outer side surface and into the at least one inner side surface.

15. The method of claim 14 wherein,
before emanating light through the one or more bore holes, further comprising,
emanating light through one or more first sections of the lighted sign;
after emanating light through the one or more bore holes, further comprising,
emanating light through one or more second sections; and
emanating light to a lighted sign center portion.

16. The method of claim 15 further comprising reflecting light through at least one of the one or more first sections, one or more second sections, and lighted sign center portion.

17. A lighted display system comprising,
an outer edge comprising one or more light sources emanating light generally towards a lighted display center;
one or more horizontal lighted display layers, wherein at least one of the horizontal lighted display layers is substantially transparent;
a display on a lighted display front surface; and
an opaque backplane.

18. The lighted display system of claim 17 wherein, the one or more light sources are LED light sources located proximal the outer edge.

19. The lighted display system of claim 17 wherein the one or more horizontal lighted display layers comprises a polymeric material.

20. The lighted display of claim 17 wherein, the display comprises a colored display on the front surface.
